(19) United States
(12) Patent Application Publication
(10) Pub. No.: US 2008/0087499 A1
(43) Pub. Date: Apr. 17, 2008

(54) CONTROL BOX FOR AN APPARATUS FOR REMOVING AND REPLACING LUBRICANTS

(76) Inventor: Russ Morgan, Comox (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/855,912

(22) Filed: Sep. 14, 2007

(30) Foreign Application Priority Data
Oct. 16, 2006 (CA) 2564276

(51) Int. Cl. F01M 11/04; F16N 33/00

(52) U.S. Cl. 184/1.5; 184/105.1

(57) ABSTRACT

A control box for an apparatus for removing and replacing lubricants has a pressurized air manifold and a vacuum manifold. The pressurized air manifold is supplied with pressurized air from a source of pressurized air. The vacuum manifold is placed under vacuum by a vacuum source. The pressurized air manifold is connected to a new lubricant hose coupling. The vacuum manifold is connected to a used lubricant hose coupling. A valve assembly is provided having a used lubricant removal mode and a new lubricant injection mode. In the used lubricant removal mode, a vacuum is applied by the vacuum manifold to create a vacuum to draw lubricant into a used lubricant tank. In the new lubricant injection mode, pressurized air is supplied by the pressurized air manifold to pressurize a new lubricant tank, which urges lubricant out of the new lubricant tank.

### FIELD

The present invention relates to a control box for use with a used lubricant tank, a replacement lubricant tank and a compressor, to remove and replace lubricants, such as lubricants from machinery.

### BACKGROUND

U.S. Pat. No. 5,476,154 (Sage) is an example of an apparatus for removing and replacing fluids.

### SUMMARY

According to the present invention there is provided a control box for an apparatus for removing and replacing lubricants. The control box includes a housing in which is positioned a pressurized air manifold and a vacuum manifold. The pressurized air manifold is supplied with pressurized air from a source of pressurized air. The vacuum manifold is placed under vacuum by a vacuum source. The pressurized air manifold is connected to a new lubricant hose coupling. The vacuum manifold is connected to a used lubricant hose coupling. A valve assembly is provided having a used lubricant removal mode and a new lubricant injection mode. In the used lubricant removal mode, a vacuum is applied by the vacuum manifold the to create a vacuum to draw lubricant into a used lubricant tank. In the new lubricant injection mode, pressurized air is supplied by the pressurized air manifold to pressurize a new lubricant tank, which urges lubricant out of the new lubricant tank.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a control box constructed in accordance with the teachings of the present invention.

FIG. 2 is a top plan view of the control box illustrated in FIG. 1 as part of an apparatus for removing and replacing lubricants, the control box being positioned on a trailer along with a used lubricant tank, a new lubricant tank, and a compressor for mobile equipment and vehicle servicing.

FIG. 3 is a detailed side elevation view of key components of a valve assembly for the control box illustrated in FIG. 1, that enables switching between modes.

FIG. 4 is a schematic view of the apparatus for removing and replacing lubricants illustrated in FIG. 2, with the valve assembly on the control box in a used lubricant removal mode.

FIG. 5 is a schematic view of the apparatus for removing and replacing lubricants illustrated in FIG. 2, with the valve assembly on the control box in a used lubricant tank emptying mode.

FIG. 6 is a schematic view of the apparatus for removing and replacing lubricants illustrated in FIG. 2, with the valve assembly on the control box in a new lubricant injection mode.

FIG. 7 is a schematic view of the apparatus for removing and replacing lubricants illustrated in FIG. 2, with the valve assembly on the control box in a new lubricant tank filling mode.

### DETAILED DESCRIPTION

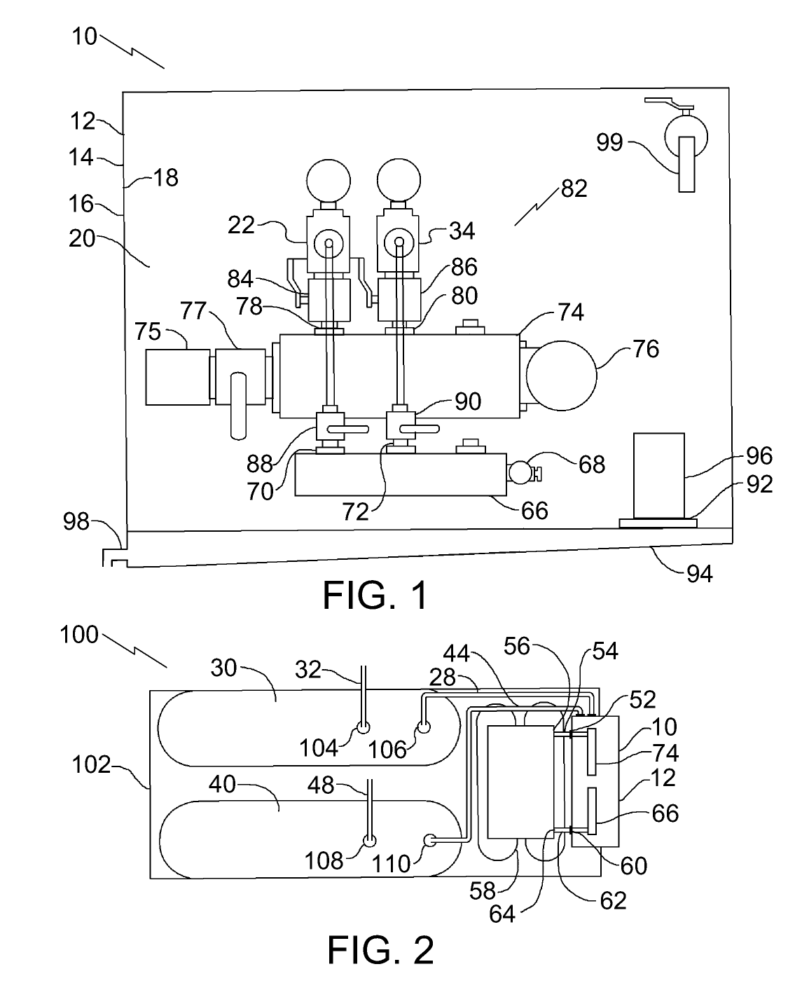

The preferred embodiment, a control box generally identified by reference numeral 10, will now be described with reference to FIG. 1 through 7.

Structure and Relationship of Parts:

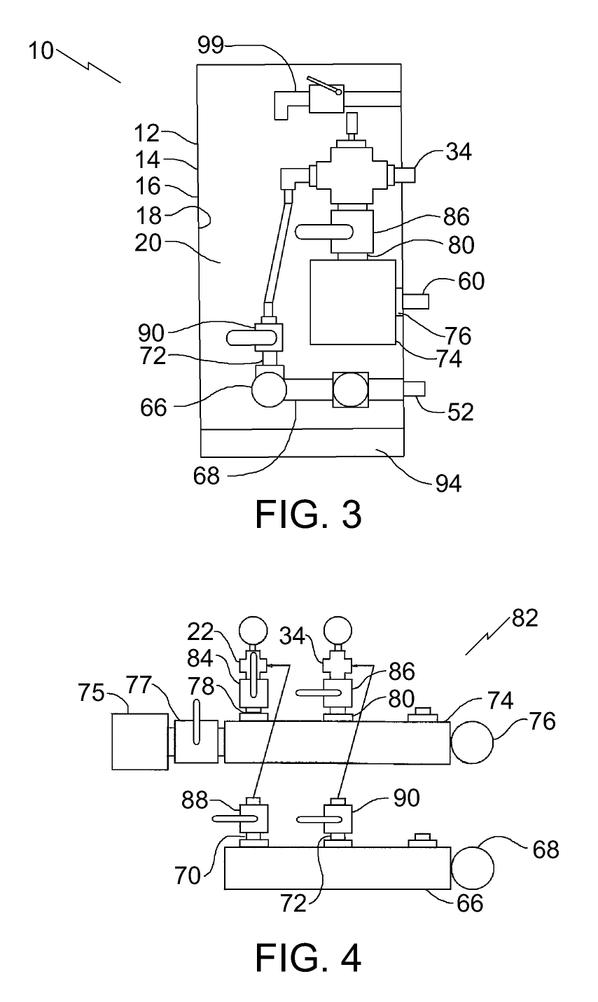

Referring to FIG. 1, control box 10 consists of a housing 12 having a sidewall 14 with an exterior surface 16 and an interior surface 18. Interior surface 18 of housing 12 defines an interior cavity 20. There is provided a used lubricant hose coupling 22, although control box 10 may be modified to include more than one. It is preferred, but not essential, that used lubricant hose coupling 22 extends through sidewall 14 so that it is accessible from exterior surface 16 of housing 12. It will be understood that an alternative to an exterior connection would be to provide a door on housing 12 with the door being opened to allow connection within interior cavity 20. Lubricant hose coupling 22 is adapted to be coupled by a hose 28, shown in FIG. 2, which extends to used a lubricant tank 30. A used lubricant conduit 32 extends from used lubricant tank 30 and is adapted for connection to a vehicle or machine having used lubricant to be replaced, as will hereinafter be further described. Referring to FIG. 1, there is a new lubricant hose coupling 34, although control box 10 may be modified to have more than one. It is preferred, but not essential, that new fluid hose coupling 34 extends through sidewall 14 so that it is accessible from exterior surface 16 of housing 12. Lubricant hose coupling 34 is adapted to be coupled by a hose 44, shown in FIG. 2, to a new lubricant tank 40. A new lubricant conduit 48 is connected to new lubricant tank 40 and is adapted to be connected to a vehicle or machine in need of new lubricant to replace used lubricant which has been removed. It will be understood that more lubricant tanks 40 may be included if more than one type or grade of lubricant is needed. Referring to FIG. 3, a pressurized air hose coupling 52 is provided. It is preferable, but not essential, that pressurized air hose coupling 52 extend through sidewall 14 so that it is accessible from exterior surface 16 of housing 12. Referring to FIG. 2, pressurized air hose coupling 52 is adapted to be coupled by a hose 54 to a source of pressurized air, which in this instance is an air output 56 of a compressor 58. Referring to FIG. 3, a vacuum hose coupling 60 is provided. It is preferred, but not essential, that vacuum hose coupling 60 extend through sidewall 14 so that it is accessible from exterior surface 16 of housing 12. Referring to FIG. 2, vacuum hose coupling 60 is adapted to be coupled by a hose 62 to a vacuum source, which in this instance is a vacuum intake 64 of compressor 58. Referring to FIG. 3, a pressurized air manifold 66 is positioned within interior cavity 18 of housing 12. Pressurized air manifold 66 has a pressurized air inlet 68 coupled to pressurized air hose coupling 52. Pressurized air is received by pressurized air manifold 66 from the source of pressurized air via pressurized air hose coupling 52. Referring to FIG. 1, pressurized air manifold 66 has more than one pressurized air outlet; two are shown in use, which for purposes of identification will be referred to as first pressurized air outlet 72 and second pressurized air outlet 70. First pressurized air outlet 72 is connected to new lubricant hose coupling 34 and second pressurized air outlet 70 is connected to used lubricant hose coupling 22. Referring to FIG. 1, a vacuum manifold 74 is positioned within interior cavity 20 of housing 12. Vacuum manifold 74 has a vacuum inlet 76 coupled to vacuum hose coupling 60. Vacuum manifold 74 also has an air inlet, which is an air filter 75 as shown, controlled by a valve 77. Valve 77 allows a single compressor to be used to both apply pressure and vacuum to pressure manifold 66 and vacuum manifold 74, respectively. Valve 77 would not be necessary if separate vacuum and pressure sources were used. A vacuum is created within vacuum manifold 74 by the vacuum source via vacuum hose coupling 60. Vacuum manifold 74 has more than one vacuum outlet; two are shown in use, which for purposes of identification have been referred to as first vacuum outlet 78 and second vacuum outlet 80. First vacuum outlet 78 is connected to used lubricant hose coupling 22. Second vacuum outlet 80 is connected to new lubricant hose coupling 34. Referring to FIG. 4, a valve assembly is provided, which is generally identified by reference numeral 82. Valve assembly 82 includes a valve 84 on first vacuum outlet 78, a valve 86 on second vacuum outlet 80, a valve 88 on first pressurized air outlet 72 and a valve 90 on second pressurized air outlet 70.

Some non-essential, but useful, supplemental features for control box 10 will now be described. Referring to FIG. 1, filter supports 92 are positioned within interior cavity 20 of housing 12, along with a drainage sump 94 which is adapted for capturing lubricants draining from filters 96 positioned on filter supports 92. Drainage sump 94 has a sloped floor that leads to a drain 98. One or more fresh lubricant spigot 99 is positioned within interior cavity 20 of housing 12 and is used when pre-filling new filters.

Operation:

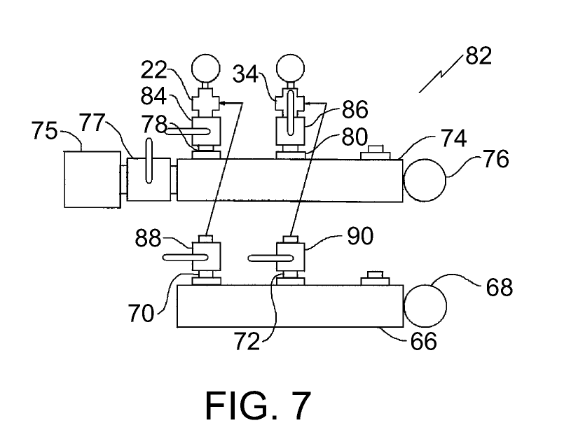

The operation of control box 10 will now be described with reference to FIG. 1, through FIG. 7. Operation will be described with reference to the apparatus for removing and replacing lubricants, illustrated in FIG. 2, and generally identified by reference numeral 100. All components for apparatus 100, described above, are mounted on a trailer 102. When control box 10 is connected to apparatus 100, there are a number of valves and connections. Those valves and connections include valves 104 and 106 on used lubricant tank and valves 108 and 110 on new lubricant tank 40.

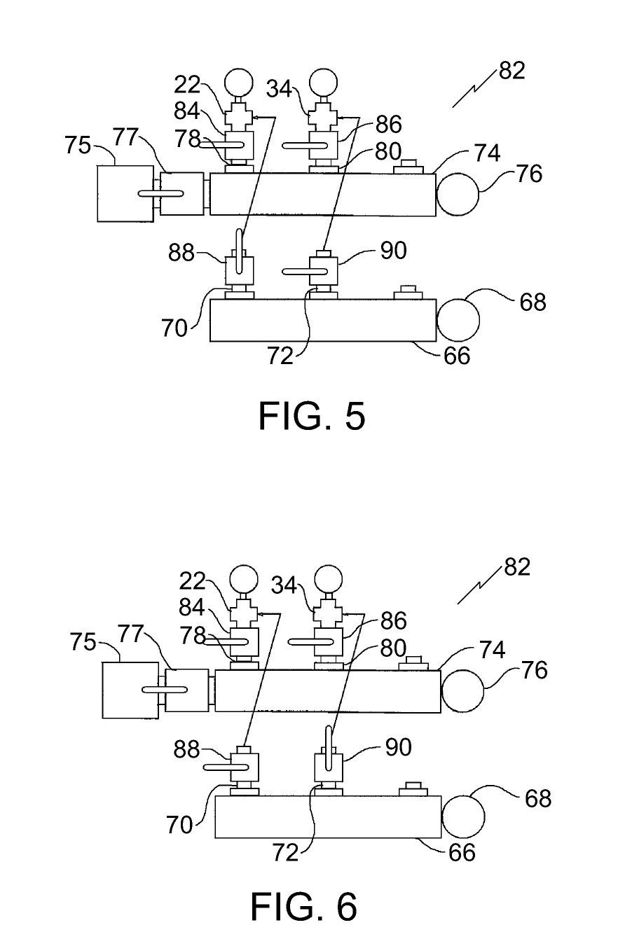

Once control box 10 is connected to apparatus 100, the key to operation is through valve assembly 82. Valve assembly 82 has a number of modes. A used lubricant removal mode is illustrated in FIG. 4. A used lubricant tank emptying mode is illustrated in FIG. 5. A new lubricant injection mode is illustrated in FIG. 6. A new lubricant tank filling mode is illustrated in FIG. 7. Referring to FIG. 4, in the used lubricant removal mode valve 84 on first vacuum outlet 78 is open to apply a vacuum to used lubricant hose coupling 22, valve 86 on second vacuum outlet 80 is closed, valve 77 is closed, valve 88 on first pressurized air outlet 70 is closed and valve 90 on second pressurized air outlet 72 is closed. Referring to FIG. 2, in the used lubricant removal mode a vacuum is created in vacuum manifold 74 by compressor 58. A vacuum is applied by vacuum manifold 74 to used lubricant hose coupling 22, thereby creating a vacuum in used lubricant tank 30 which draws lubricant along used lubricant conduit 32 from the vehicle into used lubricant tank 30. Referring to FIG. 5, in the used lubricant tank emptying mode, valve 84 on first vacuum outlet 78 is closed, valve 86 on second vacuum outlet 80 is closed, valve 77 is open, valve 88 on first pressurized air outlet 70 is closed, and valve 90 on second pressurized air outlet 72 is open to supply pressurized air to used lubricant hose coupling 22. Referring to FIG. 2, in the used lubricant tank emptying mode the valve assembly 82 switches the connection of used lubricant hose coupling 22 from vacuum manifold 74 to pressurized air manifold 66, so that used lubricant tank 30 is selectively pressurized to vacate used lubricants from used lubricant tank 30. Referring to FIG. 6, in the new lubricant injection mode, valve 84 on first vacuum outlet 78 is closed, valve 86 on second vacuum outlet 80 is closed, valve 77 is open, valve 88 on first pressurized air outlet 70 is open to apply pressurized air to new lubricant hose coupling 34 and valve 90 on second pressurized air outlet 72 is closed. Referring to FIG. 2, in the new lubricant injection mode, pressurized air manifold 66 is pressurized by compressor 58. Pressurized air is supplied by pressurized air manifold 66 to pressurize new lubricant tank 40 which urges lubricant along new lubricant conduit 48 to the machine or vehicle. Referring to FIG. 7, in the new lubricant tank filling mode, valve 84 on first vacuum outlet 78 is closed, valve 77 is closed, valve 86 on second vacuum outlet 80 is open to provide a vacuum to new lubricant hose coupling 34, valve 88 on first pressurized air outlet 70 is closed, and valve 90 on second pressurized air outlet 72 is closed. Referring to FIG. 2, in the new lubricant tank filling mode, valve assembly 82 switches the connection of the new lubricant hose coupling 34 from pressurized air manifold 66 to vacuum manifold 74, so that a vacuum is selectively created to refill new lubricant tank 40 by drawing new lubricants into new lubricant tank 40.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A control box for an apparatus for removing and replacing lubricants, comprising:
a housing having a sidewall with an exterior surface and an interior surface defining an interior cavity;
a used lubricant hose coupling adapted to be coupled by hoses to a used lubricant tank;
a new lubricant hose coupling adapted to be coupled by hoses to a new lubricant tank;
a pressurized air hose coupling adapted to be coupled by a hose to a source of pressurized air;
a vacuum hose coupling adapted to be coupled by a hose to a vacuum source;
a pressurized air manifold positioned within the interior cavity of the housing and having a pressurized air inlet coupled to the pressurized air hose coupling, such that pressurized air is received from the source of pressurized air via the pressurized air hose coupling, the pressurized air manifold having a pressurized air outlet connected to the new lubricant hose coupling;
a vacuum manifold positioned within the interior cavity of the housing and having a vacuum inlet coupled to the vacuum hose coupling, such that a vacuum is created within the vacuum manifold by the vacuum source via the vacuum hose coupling, the vacuum manifold having a vacuum outlet being connected to the used lubricant hose coupling;
a valve assembly having a used lubricant removal mode and a new lubricant injection mode, in the used lubricant removal mode a vacuum is applied by the vacuum manifold to the used lubricant tank coupling, thereby creating a vacuum in the used lubricant tank which draws lubricant into the used lubricant tank, in the new lubricant injection mode pressurized air is supplied by the pressurized air manifold to pressurize the new lubricant tank and urges lubricant out of the new lubricant tank.

2. The control box as defined in claim 1, wherein the pressurized air manifold is coupled to the at least one used lubricant hose coupling, such that the used lubricant tank can be selectively pressurized to vacate used lubricants from the used lubricant tank, the valve assembly including at least one valve which switches the connection of the at least one used lubricant hose coupling between the vacuum manifold and the pressurized air manifold.

3. The control box as defined in claim 1, wherein the vacuum manifold is coupled to the at least one new lubricant hose coupling, such that a vacuum can be selectively created to refill the new lubricant tank by drawing new lubricants into the new lubricant tank, the valve assembly including at least one valve which switches the connection of the at least one new lubricant hose coupling between the vacuum manifold and the pressurized air manifold.

4. The control box as defined in claim 1, wherein filter supports are positioned within the interior cavity of the housing, along with a drainage sump adapted for capturing lubricants draining from filters positioned on the filter supports.

5. The control box as defined in claim 4, wherein at least one fresh lubricant spigot is positioned within the interior cavity of the housing, whereby new filters may be pre-filled.

6. A control box for an apparatus for removing and replacing lubricants, comprising:
a housing having a sidewall with an exterior surface and an interior surface defining an interior cavity;
at least one used lubricant hose coupling extending through the sidewall so that it is accessible from the exterior surface of the housing and adapted to be coupled by hoses to a used lubricant tank having a used lubricant conduit adapted to be connected to a vehicle or machine having used lubricant to be replaced;
at least one new lubricant hose coupling extending through the sidewall so that it is accessible from the exterior surface of the housing and adapted to be coupled by hoses to a new lubricant tank having a new lubricant conduit adapted to be connected to a vehicle or machine in need of new lubricant to replace used lubricant which has been removed;
a pressurized air hose coupling extending through the sidewall so that it is accessible from the exterior surface of the housing and adapted to be coupled by a hose to a source of pressurized air;
a vacuum hose coupling extending through the sidewall so that it is accessible from the exterior surface of the housing and adapted to be coupled by a hose to a vacuum source;
a pressurized air manifold positioned within the interior cavity of the housing and having a pressurized air inlet coupled to the pressurized air hose coupling, such that pressurized air is received from the source of pressurized air via the pressurized air hose coupling, the pressurized air manifold having more than one pressurized air outlet, one pressurized air outlet being connected to each of the at least one new lubricant hose coupling and to each of the at least one used lubricant hose coupling;
a vacuum manifold positioned within the interior cavity of the housing and having a vacuum inlet coupled to the vacuum hose coupling, such that a vacuum is created within the vacuum manifold by the vacuum source via the vacuum hose coupling, the vacuum manifold having more than one vacuum outlet, one vacuum outlet being connected to each of the at least one used lubricant hose coupling and to each of the at least one new lubricant hose coupling;
a valve assembly having a used lubricant removal mode, a new lubricant injection mode, a used lubricant tank emptying mode and a new lubricant tank filling mode, in the used lubricant removal mode a vacuum is applied by the vacuum manifold to the used lubricant tank coupling, thereby creating a vacuum in the used lubricant tank which draws lubricant along the used lubricant conduit into the used lubricant tank, in the new lubricant injection move pressurized air is supplied by the pressurized air manifold to pressurize the new lubricant tank which urges lubricant along the new lubricant conduit to the machine or vehicle, in the used lubricant tank emptying mode the valve assembly switches the connection of the at least one used lubricant hose coupling between the vacuum manifold and the pressurized air manifold so that the used lubricant tank is selectively pressurized to vacate used lubricants from the used lubricant tank, in the new lubricant tank filling mode the valve assembly switches the connection of the at least one used lubricant hose coupling between the vacuum manifold and the pressurized air manifold so that a vacuum is selectively created to refill the new lubricant tank by drawing new lubricants into the new lubricant tank.

7. The control box as defined in claim 6, wherein filter supports are positioned within the interior cavity of the housing, along with a drainage sump adapted for capturing lubricants draining from filters positioned on the filter supports.

8. The control box as defined in claim 7, wherein at least one fresh lubricant spigot is positioned within the interior cavity of the housing, whereby new filters may be pre-filled.
